(19) United States
(12) Patent Application Publication
(10) Pub. No.: US 2023/0169546 A1
(43) Pub. Date: Jun. 1, 2023

(54) FACTORS FOR DETERMINING FAIR MARKET VALUE OF AN ART PIECE

(71) Applicants: Martin Gammon, Mill Valley, CA (US); Arjun Gupta, Tiburon, CA (US)

(72) Inventors: Martin Gammon, Mill Valley, CA (US); Arjun Gupta, Tiburon, CA (US)

(21) Appl. No.: 17/860,007

(22) Filed: Jul. 7, 2022

Related U.S. Application Data
(60) Provisional application No. 63/219,293, filed on Jul. 7, 2021.

(51) Int. Cl. G06Q 30/02

(52) U.S. Cl. CPC G06Q 30/0278

(57) ABSTRACT

A replaceability index for an artwork is calculated. Search terms relating to the artwork, such as artist name, title, date of work, among several others, are used to search various data sources. These searches retrieve records representing other artworks that are market comparables to the subject artwork. Each record is assigned a score. The total of all the scores is calculated. This sum is divided by the total number of records found and the result is a replaceability index, a value that indicates how abundant or how scarce the subject artwork is. This index may be used by a human appraiser to determine a fair market value of the subject artwork. A search term ranking for an artwork and multiple records representing market comparable artworks are used to identify the most relevant market comparables using what is referred to as ordinal priorities.

### CROSS-REFERENCE TO RELATED APPLICATIONS

This application claims priority under 35 U.S.C. § 119(e) to U.S. Provisional Application No. 63/219,293 filed Jul. 7, 2021, entitled “ART TECHNOLOGY PLATFORM”, the contents of which are hereby incorporated by reference.

### FIELD OF THE INVENTION

The present disclosure generally relates to a computer system for creating and collecting data for use in the art appraisal field. More specifically, the disclosure relates to software for calculating an index value and identifying the most relevant comparable art works which can be used for arriving at a fair market value for a subject artwork.

### BACKGROUND

Determining, as accurately as possible, a fair market value for an artwork is a mainstay in the art world. It is a cornerstone of the art market and a nearly indispensable skill of professionals in this field. As such, appraisers working in the fine art market utilize various methodologies and thought processes to arrive at an accurate fair market value. As such, there is a continuous need for additional tools and intelligence that enable them to hone their ability to arrive at fair market value for artworks.

### SUMMARY

In one aspect of the present invention, a replaceability index for an artwork is calculated. Search terms relating to the artwork, such as artist name, title, date of work, among several others, are used to search various data sources. These searches retrieve records representing other artworks that are market comparables to the subject artwork. Each record is assigned a score. The total of all the scores is calculated. This sum is divided by the total number of records found and the result is a replaceability index, a value that indicates how abundant (at one end of the availability spectrum) or how scarce (at the other end of the spectrum) the subject artwork is. This index may be used by a human appraiser to determine a fair market value of the subject artwork.

In another aspect of the invention, a search term ranking for an artwork is derived. The records identified from the replaceability index process are used. A first record is selected and the search terms are applied as filters to the record. The more filters the records gets through or survives, the higher the ordinal priority is for that record. The records with the highest ordinal priorities may be used by a human appraiser to determine a fair market value of the subject artwork.

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 is a flow diagram of a process of calculating a replaceability index in accordance with one embodiment of the present invention;

FIG. 2 is a flow diagram showing steps of a process of identifying and ranking market comparable records with respect to the subject artwork in accordance with one embodiment; and

FIG. 3 is a block diagram showing hardware and software components and modules in the platform and system in accordance with one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Various embodiments of the present invention are described in the figures. The invention has two aspects, both of which are used by a human appraiser to value an artwork or collectible (hereinafter “artwork”). One aspect is a method of deriving what is referred to as a replaceability index for an artwork. In this use case, the owner of an artwork wants to have the artwork appraised, that is, she wants to learn what the fair market value (“FMV”) of the artwork is. The task of determining the FMV is done by a human appraiser who looks at a range of factors and ultimately uses her discretion in deriving a FMV or FMV range. The replaceability index (hereinafter “index”) of the present invention is derived from software executing on a computer system and can be used as one factor by the appraiser in deriving the FMV of the subject artwork. The owner of the software and system (also referred to as “platform”) deriving the index of the present invention is referred to as administrator.

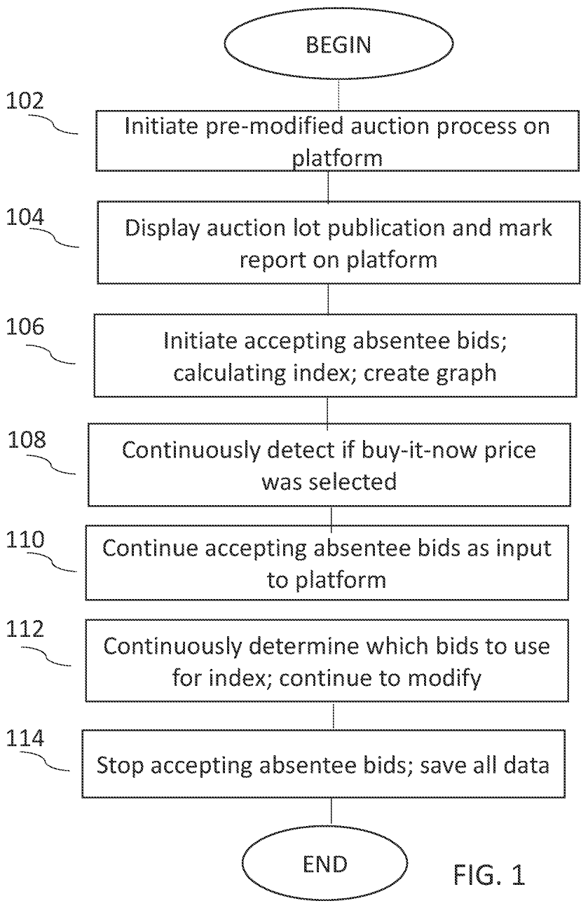

FIG. 1 is a flow diagram of a process of calculating a replaceability index in accordance with one embodiment of the present invention. In one use case, the owner of the subject artwork supplies search terms to the administrator who provides it to an appraiser. The appraiser (who may be the same entity as the administrator) may also determine some search terms relevant to the subject artwork. A software module in the platform or system accepts search term input from the owner, for example, via a form. In either case, at step 102 a group of search terms (T1, T2, T3, etc.) is created. Examples of search terms include artist last name, proper name of the artwork, artist date of birth, date of artwork, medium, artwork dimensions, artwork image features, exhibition history, among others.

At step 104 the search terms are used to search one source of art data, specifically a propriety data source that contains public auction records and other data. In one embodiment, the proprietary data source is managed by the administrator and is stored in a memory in the platform or system. In most cases, when there is a public auction of an artwork, data collected during that auction (artwork titles, artist names, date of sale, medium, prices, etc.) are stored electronically and the administrator can build its proprietary database using these data. This proprietary data source is searched using the search terms derived at step 102. As a result of this search, n number of records are retrieved.

At step 106 the system calculates a score for each public auction record found based on a novel methodology. This is done by a record score calculation module in the system. For example, each public or proprietary auction record (hereinafter “public” record) is designated a numerical value on a scale of 1 to 10. The value of this designation is based on when the artwork was sold. An early date of sale for an artwork may imply that it has a higher likelihood of returning to the market sooner (than, for example, an artwork that was sold more recently at auction). Artworks sold in the last year, for example, receive a value of 1 (highly unlikely to be reoffered soon). Works sold in the one-to-two year range, for example, may be designated a value of 2, if sold two to three years ago, it may be given a value of 3, and so on up to a value of 10 if the artwork was sold 10 or more years ago.

At step 108 the system searches private art data sources using the same search terms. The administrator may have rights to search these various private sources. These private art data sources may be part of the proprietary data source managed by the administrator. In one embodiment, at step 110 each record found in this search is given a score that is on the same scale as the scores assigned at step 106. For example, using the scale from the public search, each record is assigned a score of 10 (the highest score). In this embodiment, these records are given a high score of 10 because the probability of one of them coming to market is aligned with those artworks sold 10 years ago or later.

It is helpful to note that a record (as used in the proprietary and private art source searches and in the museum search described below) is a record of data for a single artwork that is comparable to the subject artwork. This artwork is often referred to as a “market comparable.” The number of fields in these records, that is, the information they contain can vary but most of them will have the same basic information as noted above so that the record may be ultimately useful for appraisal purposes.

At step 112 the system searches museum data sources using the same search terms as above. At step 114 records found in this search are assigned a value of 1 using the same scale as above. They are assigned the lowest value of 1 since the artworks corresponding to these records are highly unlikely to be sold at auction or be deaccessioned by the museum.

At this stage the system has a certain number of records that it has retrieved from various art data sources. Each record has a score and each score is on the same scale as the other scores, for example, between 1 and 10, as described above. For example, a record from the museum search has a score of 1 and this score has meaning and context relative to the scores assigned to records retrieved in the public art source search (between 1 and 10). At step 116 the system calculates an index for the subject artwork. This is done by an index calculation module in the system. In one embodiment, this is done by adding all the scores assigned to the records. This total is divided by the total number of records retrieved. An example of this is provided below.

Public auction records: 10 works sold over the last ten years. Y1: 1, Y2: 2; Y3: 0; Y4: 1; Y5: 0: Y6: 2: Y7: 0; Y8: 2; Y9: 0; Y10: 2. The corresponding values: 1, 4, 4, 12, 16, 20 =57. Private records: 15×10=150 and Museum records: 40×1=40. The SUM of all numerical values=247, divided by total sample of 65 works, equals a Replaceability Index of 3.8/10. This implies roughly a 38% chance that another artwork matching the key terms search will appear at public auction in the coming year.

The replaceability index is a gauge of the availability of the subject artwork. A low index value indicates that artworks similar to the subject artwork are scarce; they will be difficult to find in the art market and are unlikely to come up for auction. A high index value indicates that artworks similar to the subject artwork are available, that is, they may not be difficult to find and may come up for auction. A very high index value indicates that similar artworks are abundant. What values are considered “high” and “low” can be determined or set by the administrator of the system who may use, for example, quantitative factors such as the number of records found in each category (public/proprietary, private, museum), and if needed qualitative ones.

As noted, the index is calculated by software executing on the system. The index value can be used by a human appraiser (who may be the same as the administrator) in the appraiser's discretion in arriving at an FMV for the subject artwork. Other factors the appraiser may use include quality of the artwork, aesthetic features, and the like, all of which may be used to derive a demand curve for the subject artwork.

As noted, the index can be used by an appraiser to determine demand for the subject artwork. A low index may indicate that the artwork is scarce and presumably there would be high demand for it. In this light, the index may also be a factor that an art advisor may use in determining potential auction or sales outcomes.

It is useful to note that the three searches described can be performed by the system in a sequence dictated by the administrator who can also decide to leave out one or more searches when deriving the index.

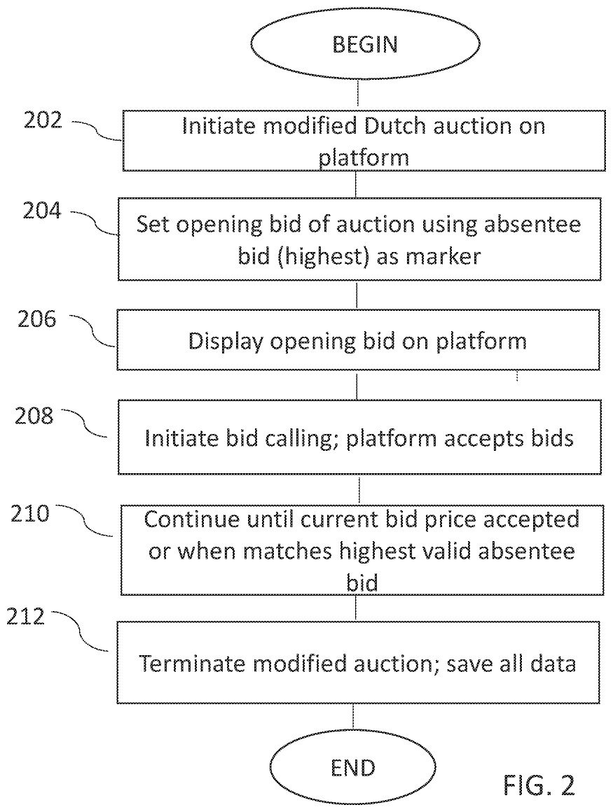

In another aspect of the present invention, the most relevant market comparable records with respect to the subject artwork are identified by the system. These records may be used by an appraiser as another factor in determining the FMV of the subject artwork. The process of identifying the most relevant records is shown in FIG. 2. Certain data from the replaceability index process are used in the process described in FIG. 2. These data are the collective group of records identified in the three searches performed in FIG. 1 and the search terms used to identify them.

As noted, FIG. 2 is a flow diagram of a process of identifying and ranking market comparable records with respect to the subject artwork in accordance with one embodiment. At step 202, the search terms used in the process for deriving the index are ranked. In a simple example, the artist's last name is ranked as one, the proper name or auction title is ranked as two, the date of the artwork is ranked as three, and so on. The administrator of the system can rank the terms or provide instructions to the system on how the terms should be ranked based on relevancy. The system has a search term ranking module that accepts as input the terms and criteria on how to rank them or instructions directly from the administrator. Regardless of the manner in which the ranking is done, in one embodiment all the search terms are given a rank and no two search terms can be ranked the same. This is the system's search term ranking utilized in the process below.

At step 204 a record from the set of records identified in FIG. 1 is retrieved. In one embodiment, the order of the records retrieved is irrelevant; it may be a public or proprietary record, a museum record, or a private record. As noted below, this is an iterative process such that the process ends when records from the set have been analyzed as is described in the next step. At step 206 the record is analyzed by the system using the previously derived search term ranking. The analysis of a record at step 206 results in a what is referred to as an ordinal priority for that record.

An ordinal priority (a numerical value) is assigned to the record using the search terms in their ranked order and is performed by an ordinal priority assignment module in the system. The first ranked search term, artist's last name, is used to filter the record. If the artist's last name is in the record, the record is kept by the system. This is done for each of the records in the set. As would be expected, all (or nearly all) the records will be kept because it is expected that the artist's name will be in the record. The same process is done with the second highest ranked search term, for example, proper name of the artwork. This search term is applied to each record. It is now likely that a few of the records will be dropped given that not every record will have the proper name of the subject artwork. This is then done using the third highest ranked search term for each record that survived the second highest ranked term. If the third ranked term is date of the artwork, then it is expected that only some of the surviving records will have the same date and so the number of records narrows. The process continues for each ranked search term (each iteration using a lower ranked term) in a cascading manner, winnowing down the number of records from the initial set of records. During this process, each record is assigned an ordinal priority. Those records with the highest ordinal priority value are the ones that survived the iterative processing using the ranked search terms. The records that were eliminated early have a low priority and the ones that survived, for example, the fifth or sixth ranked search terms have the highest ordinal priority.

This process is what occurs at step 208, where each record is analyzed or filtered using the ranked search terms and given an ordinal priority. In one embodiment, the system ranks the records based on ordinal priority value. This may be done by an ordinal priority record ranking module in the system. The records with the highest ordinal priority value are ranked the highest. It is these records that represent the most relevant market comparable artworks with respect to the subject artwork. These records (having the highest ordinal priority values) are provided to a human appraiser who can use them in deriving a FMV for the subject artwork.

In one example, there are 12 records. After applying search terms T1, T2, T3, etc. as a filter until the lowest ranked search term is reached, there may only be three records. With these remaining three records, the system may apply, in one embodiment, an image recognition tool if, for example, there is a search term which relates to color scheme or image recognition. This may further narrow the number of records to only two records. These two records represent artworks that are most relevant to the subject artwork.

In one embodiment, the ordinal priority ranking system described above may be used to automatically extrapolate provisional values to unvalued artworks (which have similar features to the subject artwork) by using known values in the public auction databases to artworks in museum art data sources and private collection databases. For example, there may be x number of artworks in a given market category, for example a 100. Of those, 15 have sold at auction and the other 85 are divided between museum records and private sales records (e.g., 40 and 45, respectively). The system is able to extend the known values from the 15 artworks that have confirmed prices to the 85 unsold artworks by deploying a similar ordinal priority ranking methodology to identify the closest market comparable records between sold and unsold artworks. The system can provide a provisional FMV “range” for an appraiser to then review, refine, and codify.

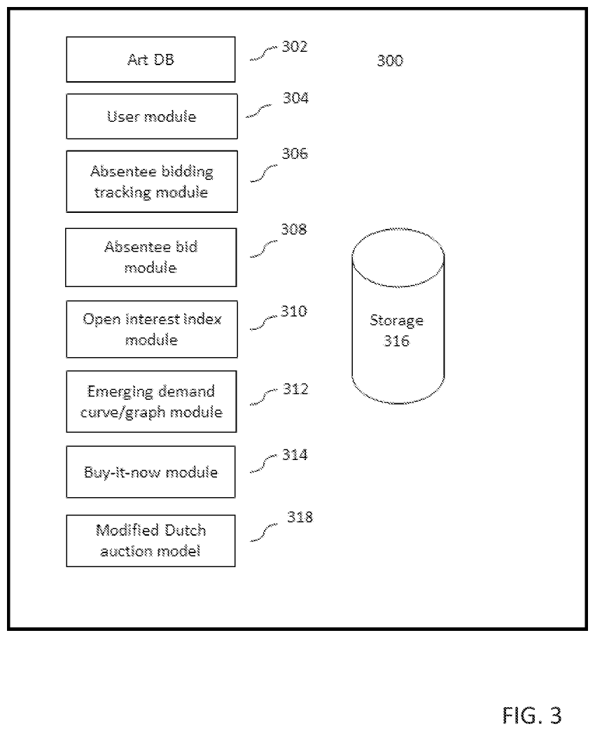

FIG. 3 is a block diagram showing hardware and software components and modules in the modified auction platform and system in accordance with one embodiment of the present invention. These components and modules are utilized to implement the functions, algorithms, and features described in FIGS. 1 and 2 and to execute the software and store the various types of data. As will be seen, a single software module may perform multiple different functions and operations available on the platform. Many of these components and modules have already been described while describing the processes in FIGS. 1 and 2.

What is claimed is:

1. A method of calculating a replaceability index for an artwork, the method comprising:
selecting a plurality of search terms;
searching a first database using the search terms thereby identifying one or more records and assigning a score to reach record;
searching a second database using the search terms thereby identifying one or more records and assigning the same second score to each record;
searching a third database using the search terms thereby identifying one or more records and assigning the same third score to each record; and
calculating a replaceability index using the totality of the scores and the totality of the number of records.
